(19) United States
(12) Patent Application Publication
(10) Pub. No.: US 2013/0306457 A1
(43) Pub. Date: Nov. 21, 2013

(54) MULTI-DIRECTIONAL KEY ASSEMBLY

(71) Applicants: Chien-Chuan Pan, New Taipei City (TW); OBO PRO.2 INC., Taoyuan City (TW)

(72) Inventor: Chien-Chuan PAN, New Taipei City (TW)

(73) Assignees: OBO PRO.2 INC., Taoyuan City (TW); Chien-Chuan Pan, New Taipei City (TW)

(21) Appl. No.: 13/895,985

(22) Filed: May 16, 2013

(30) Foreign Application Priority Data
May 21, 2012 (TW) 101118020

(51) Int. Cl. H01H 13/64

(52) U.S. Cl. CPC H01H 13/64
USPC 200/5 E

(57) ABSTRACT

A multi-directional key assembly is mounted on an electronic device to control the electronic device, and has a pressing module, a circuit board, and a housing. The pressing module has a flexible first panel, at least one dividing groove, multiple pressing portions, and multiple first contact elements. The at least one dividing groove divides the first contact elements from one another. Each pressing portion corresponds to and drives one of the first contact elements. The circuit board has multiple signal generators respectively corresponding to the first contact elements. The housing has multiple dividing protrusions protruding toward the first panel. The dividing grooves and the dividing protrusions divide the first panel into multiple sections. Thus, when one of the pressing portions is pressed, only one of the first contact elements moves. The other first contact elements do not move simultaneously.

### BACKGROUND OF THE INVENTION

1. Field of the Invention

The present invention relates to a key assembly for an electronic device, especially to a multi-directional key assembly that prevents a user from miss-pressing the keys.

2. Description of the Prior Art(s)

With progress of technologies, modern people enjoy an improved quality of life with a variety of electronic technologies. People use portable electronic devices, such as mobile phones, smart phones, personal digital assistants (PDAs), notebook computers, MPEG Audio Layer III (MP3) players, Universal Serial Bus (USB) flash drives, iPads, iPods, iPhones, e-book readers, or the like, to fulfill basic needs of their daily lives.

Generally, the electronic device has a housing, a printed circuit board (PCB) mounted in the housing, multiple electronic components disposed on the PCB, and multiple keys mounted on the housing. When a user is using the electronic device, the user presses the keys to actuate the electronic components. Accordingly, the electronic components output signals to drive and control hardware and software of the electronic device.

With the increasing need for carrying the electronic devices around, the electronic devices are designed to have various and complicated functions, and light, slim, small and pleasing appearances. However, a miniaturized electronic device also has keys with reduced sizes and shortened distances between the keys. Therefore, when the user intends to press one of the keys with his finger, the other surrounding keys might also be pressed. When the sizes of the keys are reduced and the distances between the keys are shortened, it is difficult to design a key assembly that prevents the user from miss-pressing the keys.

To overcome the shortcomings, the present invention provides a multi-directional key assembly to mitigate or obviate the aforementioned problems.

### SUMMARY OF THE INVENTION

The main objective of the present invention is to provide a multi-directional key assembly. The multi-directional key assembly is mounted on an electronic device to control the electronic device, and has a pressing module, a circuit board, and a housing. The pressing module has a flexible first panel, at least one dividing groove, multiple pressing portions, and multiple first contact elements. The at least one dividing groove divides the first contact elements from one another. Each pressing portion corresponds to and drives one first contact element. The circuit board has multiple signal generators respectively corresponding to the first contact elements. The housing has a second panel having multiple through holes and multiple dividing protrusions. The through holes are respectively mounted around the first contact elements. The dividing protrusions protrude toward the first panel.

The dividing grooves and the dividing protrusions divide the first panel into multiple sections. Thus, when one of the pressing portions is pressed, only one of the first contact elements moves. The other first contact elements do not move simultaneously.

Other objectives, advantages and novel features of the invention will become more apparent from the following detailed description when taken in conjunction with the accompanying drawings.

### BRIEF DESCRIPTION OF THE DRAWINGS

FIG. 1A is an exploded perspective view of a first embodiment of a multi-directional key assembly in accordance with the present invention;

FIG. 1B is another exploded perspective view of the multi-directional key assembly in FIG. 1A;

FIG. 2A is a partially exploded perspective view of the multi-directional key assembly in FIG. 1A;

FIG. 2B is another partially exploded perspective view of the multi-directional key assembly in FIG. 1A;

FIG. 3A is a perspective view of the multi-directional key assembly in FIG. 1A;

FIG. 3B is another perspective view of the multi-directional key assembly in FIG. 1A;

FIG. 4 is a cross-sectional side view of the multi-directional key assembly in FIG. 1A;

FIG. 5 is a side view of a first panel of a second embodiment of a multi-directional key assembly in accordance with the present invention, showing two adjacent dividing grooves both disposed on a lower surface of the first panel;

FIG. 6 is a side view of a first panel of a third embodiment of a multi-directional key assembly in accordance with the present invention, showing two adjacent dividing grooves respectively disposed on a lower surface and an upper surface of the first panel;

FIG. 7 is a side view of a first panel of a fourth embodiment of a multi-directional key assembly in accordance with the present invention, showing two adjacent dividing grooves both disposed on an upper surface of the first panel;

FIG. 8A is an exploded perspective view of a fifth embodiment of a multi-directional key assembly in accordance with the present invention;

FIG. 8B is another exploded perspective view of the multi-directional key assembly in FIG. 8A; and

FIG. 9 is a cross-sectional side view of the multi-directional key assembly in FIG. 8A.

### DETAILED DESCRIPTION OF THE PREFERRED EMBODIMENTS

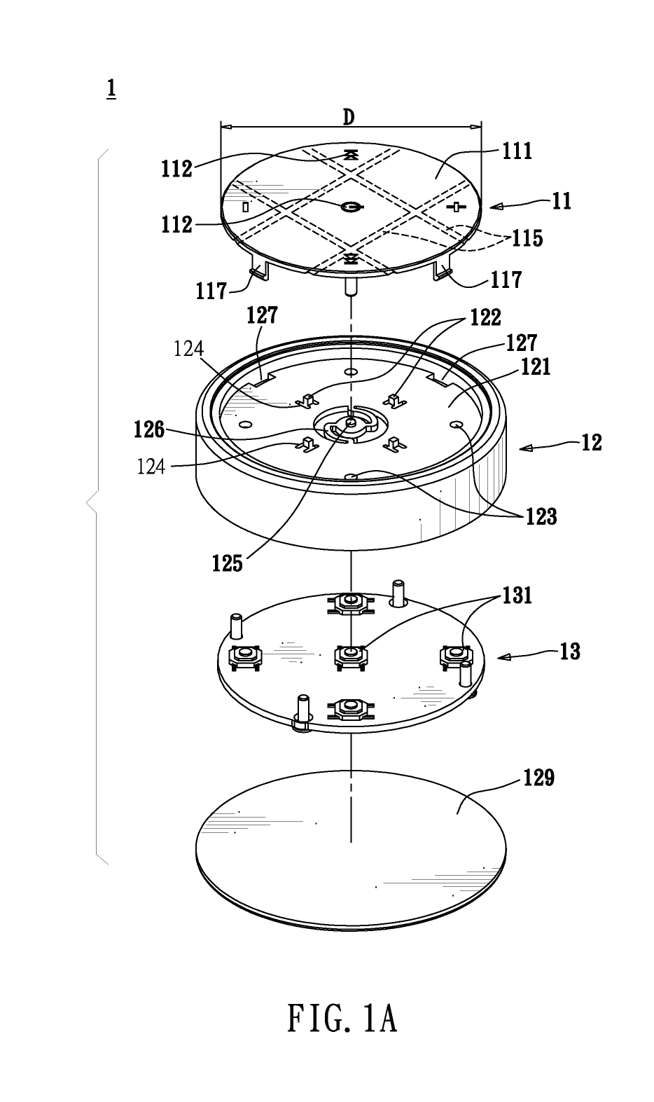

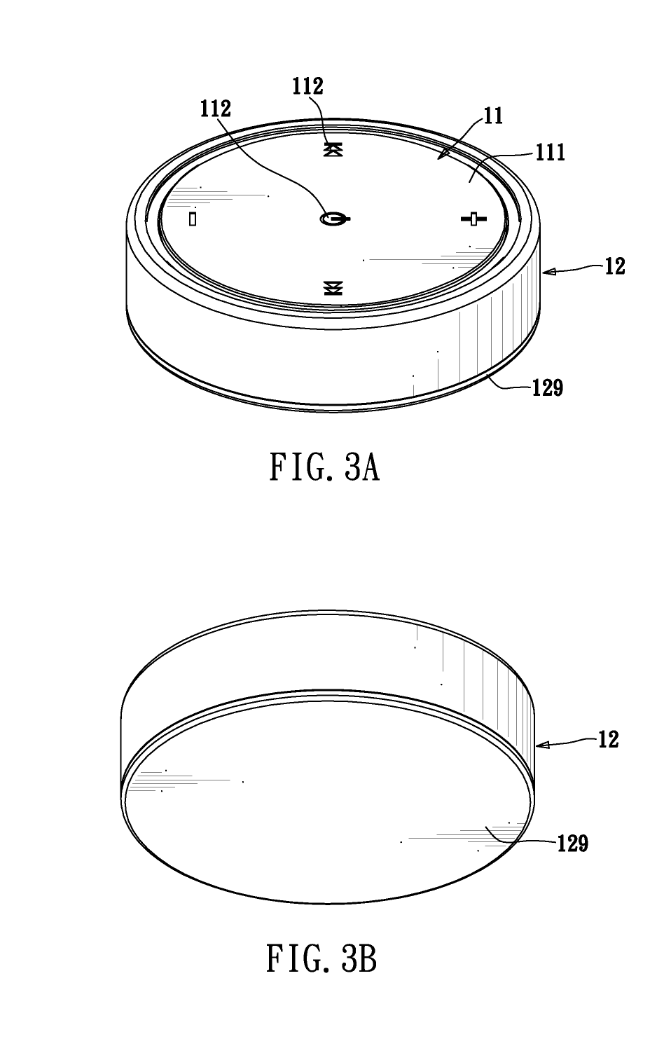

With reference to FIGS. 1A, 1B and 4, a first embodiment of a multi-directional key assembly 1 in accordance with the present invention is mounted on an electronic device (not shown) in order to control hardware and software of the electronic device. Preferably, the electronic device may be, but not limited to, a portable electronic device such as a mobile phone, a smart phone, a personal digital assistant (PDA), a notebook computer, an MPEG Audio Layer III (MP3) player, a Universal Serial Bus (USB) flash drive, an iPad, an iPod, an iPhone, an e-book reader, or the like. The multi-directional key assembly 1 comprises a pressing module 11, a circuit board 13 and a housing 12.

The pressing module 11 has a flexible first panel 111, at least one dividing groove 115, multiple pressing portions 112, multiple first contact elements 113, at least one second contact element 114, and multiple engaging elements 117.

The first panel 111 has a peripheral edge and two opposite surfaces. The two opposite two surfaces of the first panel 111 are an upper surface and a lower surface.

As shown in FIG. 1A, the at least one dividing groove 115 is disposed on the first panel 111 and divides the first panel 111 into multiple sections. Each of the at least one dividing groove 115 extends linearly. Specifically, the pressing module 11 has multiple dividing grooves 115. The dividing grooves 115 are parallel to each other or cross each other.

The pressing portions 112 are separately disposed on the upper surface of the first panel 111, are respectively disposed in the sections of the first panel 111, and are respectively labeled with different symbols indicating different functions. According to the symbols, a user can clearly identify which function he will actuate.

As shown in FIG. 1B, the first contact elements 113 are separately disposed on the lower surface of the first panel 111, are respectively disposed in the sections of the first panel 111, and respectively correspond to the pressing portions 112. Each first contact element 113 moves together with a corresponding pressing portion 112 along a moving path. Since the first panel 111 is flexible and can slightly be recessed downward and restored upward, each first contact element 113 can be driven by a corresponding pressing portion 112. Thus, when one of the pressing portions 112 is pressed, the corresponding first contact element 113 accordingly moves downwardly.

The at least one second contact element 114 is disposed on the lower surface of the first panel 111. Each of the at least one second contact element 114 is disposed in one of the sections of the first panel 111, and corresponds to and is driven by one of the pressing portions 112.

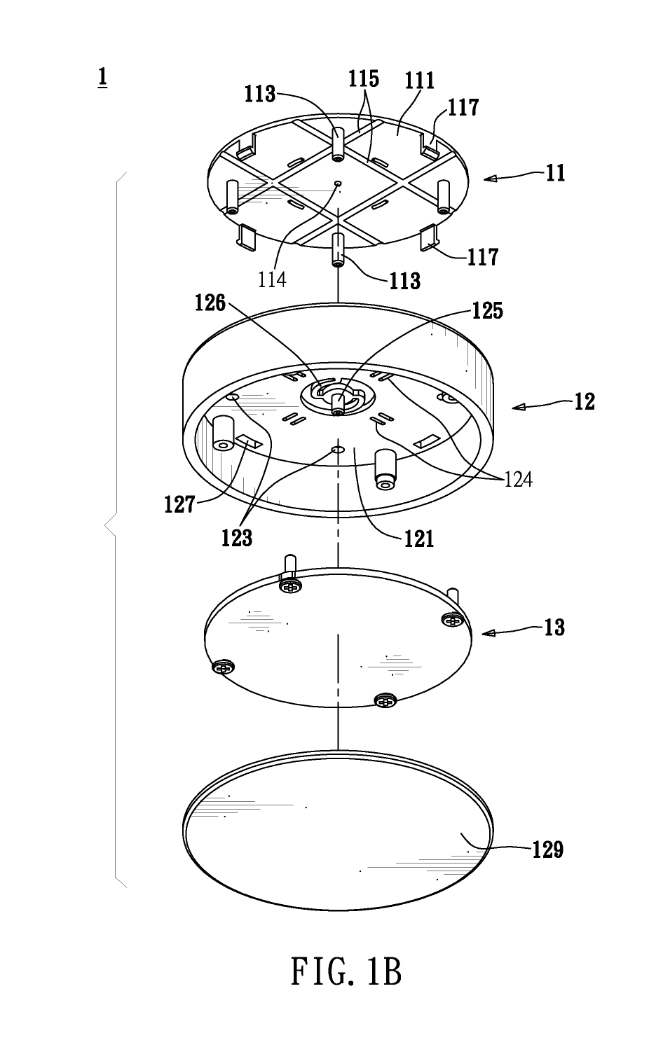

With further reference to FIGS. 2A and 2B, the engaging elements 117 separately protrude down from the peripheral edge of the first panel 111.

The circuit board 13 is disposed below the pressing module 11 and has a peripheral edge and multiple signal generators 131. The signal generators 131 are disposed on an upper surface of the circuit board 13 and respectively correspond to the first contact elements 113. Each signal generator 131 is disposed on the moving path of a corresponding first contact element 113. Thus, the first contact elements 113 can directly press against the signal generators 131 to allow the signal generators 131 to output signals.

The housing 12 may be, but not limited to, cylindrical, is used for mounting the pressing module 11 and the circuit board 13, and has two opposite side portions, a second panel 121, multiple through holes 123, multiple dividing protrusions 122, at least one indirect contact element 125, multiple engaging slots 127 and a bottom panel 129. The two opposite side portions of the housing 12 are a top portion and a bottom portion.

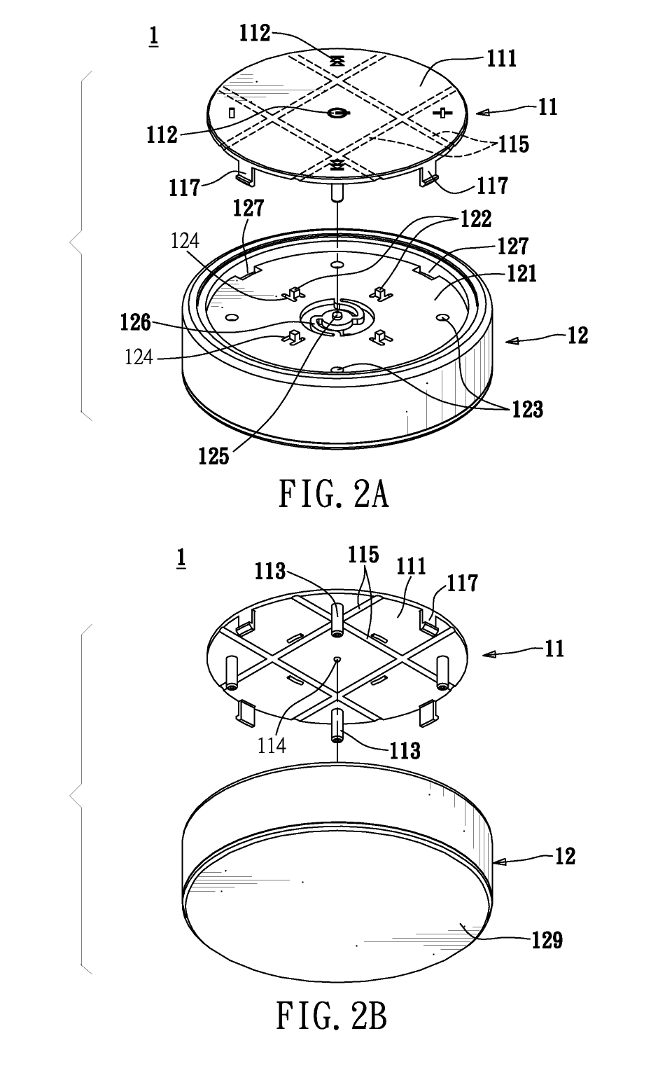

With further reference to FIGS. 3A and 4, the second panel 121 is disposed in the housing 121 and is disposed adjacent to the top portion of the housing 12. The pressing module 11 is mounted above the second panel 121, and is securely mounted on the top portion of the housing 12 with a close fit. Specifically, the housing 12 is securely attached to the peripheral edge of the first panel. The circuit board 13 is mounted below the second panel 121, and is securely mounted in the housing 12 with a close fit. Specifically, the housing 12 is securely attached to the peripheral edge of the circuit board 30. Thus, the pressing module 11 and the circuit board 13 do not drop from the housing 12.

The through holes 123 are formed through the second panel 121, and respectively correspond to and are respectively disposed around the first contact elements 113. When one of the pressing portions 112 is pressed, the corresponding first contact element 113 slides in a corresponding through hole 123.

The dividing protrusions 122 are disposed on an upper surface of the second panel 121. Each dividing protrusion 122 is disposed between two of the first contact elements 113 that are adjacent to each other. Each dividing protrusion 122 has a distal end. The distal end of the dividing protrusion 122 corresponds to and does not contact the first panel 111. Thus, when one of the pressing portions 121 is pressed and the corresponding first contact element 113 moves, the dividing protrusions 122 abut and support the first panel 111, and divide the first panel 111 into multiple sections, such that the other first contact elements 113 do not move simultaneously.

Preferably, each dividing protrusion 122 may be connected to the second panel 121 via a buffering structure 124. The buffering structure 124 comprises two buffering slots respectively formed beside two opposite sides of the dividing protrusion 122. Thus, when the first panel 111 is pressed against the dividing protrusion 122, the buffering structure 124 buffers and retards a pressure applied to the dividing protrusion 122. Accordingly, the pressure is transmitted to the second panel 121 and the housing 12 indirectly.

The at least one indirect contact element 125 is disposed on the second panel 121 and is flexible. Each of the at least one indirect contact element 125 corresponds to one of the at least one second contact element 114, and corresponds to one of the signal generators 131. The corresponding second contact element 114, indirect contact element 125, and signal generator 131 are arranged in a line. Each of the at least one indirect contact element 125 is connected to the second panel 121 via at least one resilient element 126. Specifically, each of the at least one indirect contact element 125 is connected to the second panel 121 via two resilient elements 126. Each of the at least one indirect contact element 125 has an upper end and a lower end. The upper end of the indirect contact element 125 corresponds to a corresponding second contact element 114. The lower end of the indirect contact element 125 corresponds to a corresponding signal generator 131. Thus, the at least one second contact element 114 can indirectly press against the corresponding signal generator 131 via the at least one contact element 125.

As shown in FIGS. 2A and 2B, the engaging slots 127 are separately formed through the second panel 121 of the housing 12, and respectively correspond to the engaging elements 117 of the pressing module 11. As the engaging elements 117 of the pressing module 11 are mounted through the engaging slots 127 of the housing 12, the engaging elements 117 hook the housing 12. Accordingly, the pressing module 11 is further securely mounted on the housing 12.

With further reference to FIG. 3B, the bottom panel 129 is securely mounted on the bottom portion of the housing 12 to support elements that are mounted in the housing 12 and to prevent the elements from dropping out of the housing 12.

With reference to FIG. 4, since the first panel 111 is thinned at the positions where the dividing grooves 115 are formed, the first panel 111 has higher flexibility at positions with the dividing grooves 115 than at positions without the dividing grooves 115. Therefore, each section of the first panel 111 can move independently.

The multi-directional key assembly 1 as described has the following advantages. As size of the electronic device is miniaturized, a diameter D of the multi-directional key assembly 1 is shortened. Therefore, with the dividing grooves 115 that divide the first panel 111 and the dividing protrusions 122 that support the first panel 111, the first contact elements 113 can move independently. Even though distances between the pressing portions 112 are reduced, when any one of the first contact elements 113 is pressed, the other first contact elements 113 do not move simultaneously. Accordingly, the electronic device with the multi-directional key assembly 1 can have a reduced size.

In the above-mentioned first embodiment of the multi-directional key assembly 1, the pressing module 11 may have one second contact element 114 while the housing 12 may also have one indirect contact element 125 corresponding to the second contact element 114. Alternatively, the pressing module 11 may have multiple second contact elements 114 while the housing 12 may also have multiple indirect contact elements 125 respectively corresponding to the second contact elements 114. Furthermore, the first panel 111 may directly press against all of the signal generators 131 with the first contact elements 113. Or the first panel 111 may directly press against some of the signal generators 131 with the first contact elements 113 and indirectly press against the other signal generators 131 with the second contact elements 114 and the indirect contact elements 125.

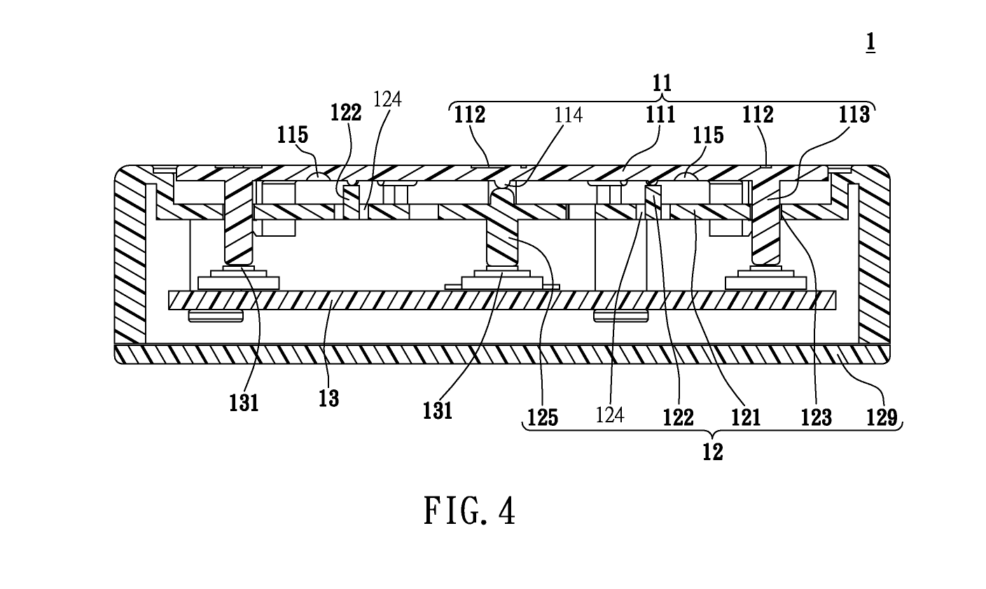

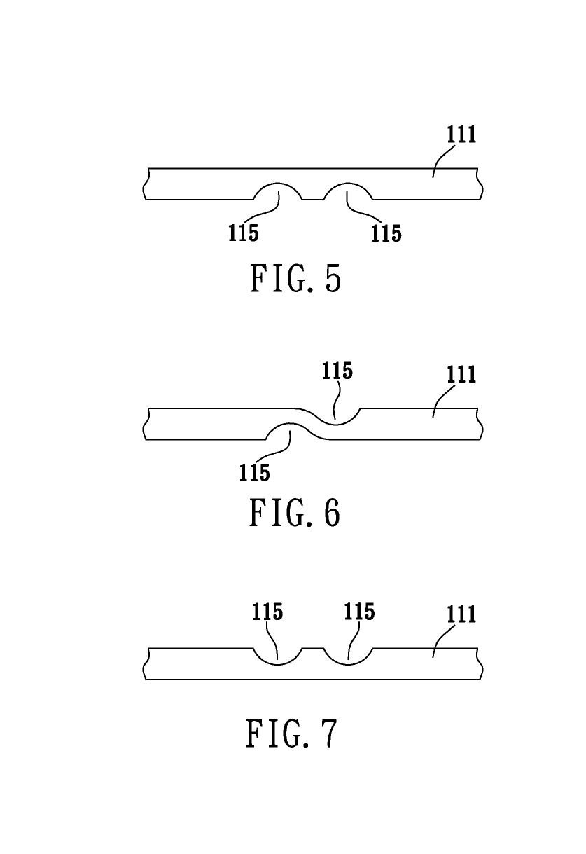

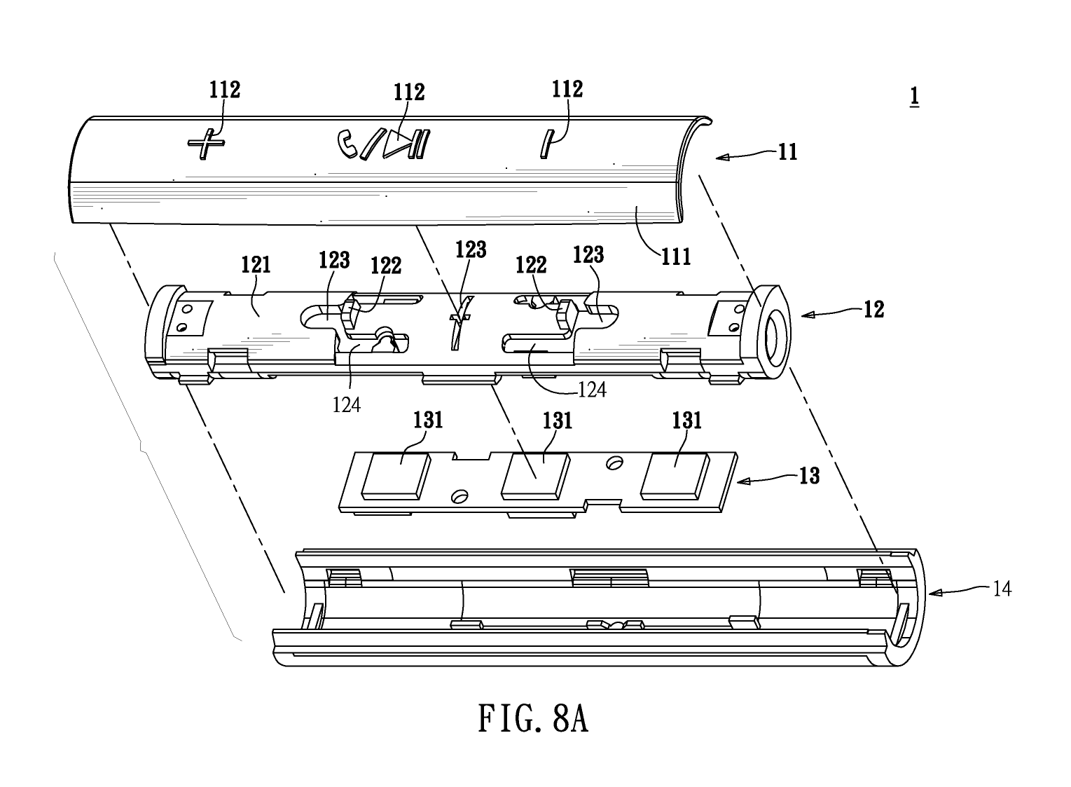

With reference to FIGS. 5, 6, and 7, each two of the dividing grooves 115 are disposed parallel and next to each other. Flexibilities of the first panel 111 at where each two of the dividing grooves are disposed 115 are improved. Accordingly, each section of the first panel 11 can move independently without affecting neighboring sections of the first panel 11. As shown in FIG. 5, the two dividing grooves 115 may be both disposed on the lower surface of the first panel 111. As shown in FIG. 6, one dividing groove 115 may be disposed on the lower surface of the first panel 111 while the other dividing groove may be disposed on the upper surface of the first panel 111. As shown in FIG. 7, the two dividing grooves 115 may be both disposed on the upper surface of the first panel 111. With one or both dividing grooves 115 disposed on the upper surface of the first panel 111, the dividing grooves 115 are shown on an appearance of the multi-directional key assembly 1 that is mounted on the electronic device.

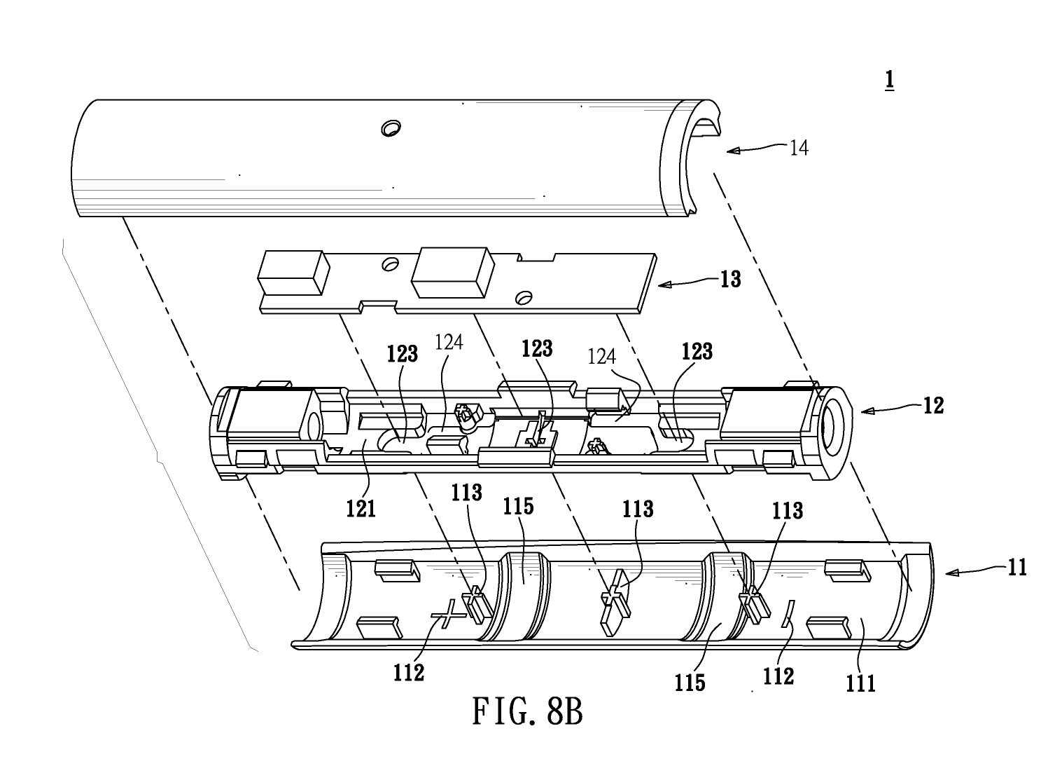

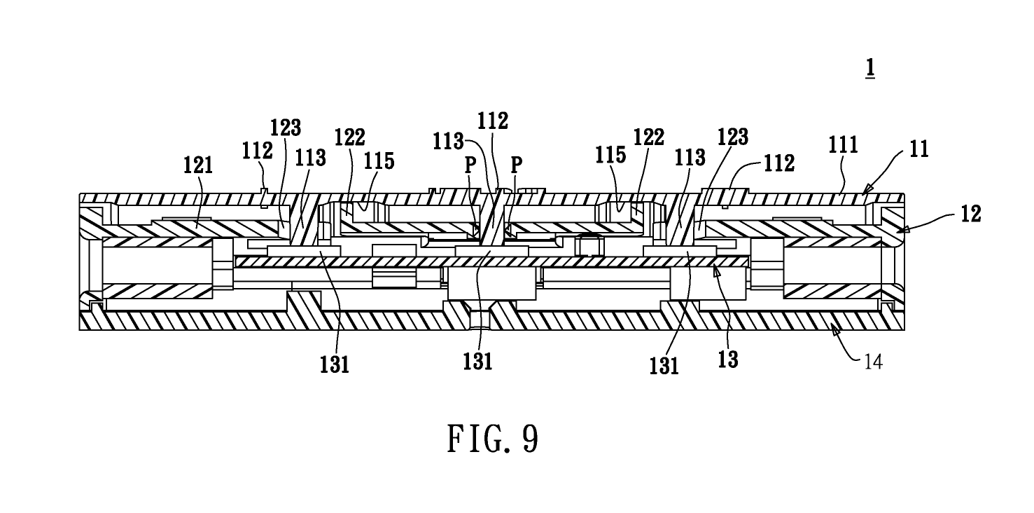

With reference to FIGS. 8A, 8B, and 9, a second preferred embodiment of the multi-directional key assembly 1 in accordance with the present invention comprises the pressing module 11, the housing 12, and the circuit board 13 as described, and further comprises a bottom cover 14. The bottom cover 14 is attached to the pressing module 11 to form an elongated cylinder. The housing 12 and the circuit board 13 are securely mounted between the pressing module 11 and the bottom cover 14.

In the second preferred embodiment, the through holes 123 of the housing 12 may be cross-shaped or irregularly shaped. The dividing grooves 115, the pressing portions 112, and the first contact elements 113 are all disposed on the first panel 111. The dividing grooves 115 are recessed in the first panel 111, and divide the first contact elements 113 from one another.

As shown in FIG. 9, the housing 12 has two dividing protrusions 122 disposed on the second panel 121. Each dividing protrusion 122 is disposed between two of the first contact elements 113. The distal ends of the two dividing protrusions 122 correspond to the first panel 111. The distal ends of the two dividing protrusions 122 are disposed adjacent to the dividing grooves, or the dividing protrusions 122 protrude in the dividing grooves 115 and abut the first panel 111. Thus, when the user presses one of the pressing portions 112, part of the first panel 111 is pressed down to drive the corresponding first contact element 113 to actuate the corresponding signal generator 131. With further reference to FIG. 8B, for the time being, the dividing protrusions 122 support the first panel 111 and two holding points P of a hole edge defined around the through hole 123 to hold the corresponding first contact element 113, such that the first panel 111 is partially bent like a seesaw. The two holding points P form a pivot of the seesaw.

Therefore, the first contact elements 113 can move independently. Even though distances between the pressing portions 112 are reduced, the first contact elements 113 do not move simultaneously when any one of the first contact elements 113 is pressed.

Furthermore, in the second preferred embodiment, the dividing grooves 115 are disposed on the lower surface of the first panel 111. Each of the dividing grooves 115 extends in an arc shape. Moreover, besides cylindrical or elongated cylinder, the multi-directional key assembly 1 may also form a polygon, such as rectangular, triangular, cuboid or the like.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multi-directional key assembly comprising:
a pressing module having
a flexible first panel;
at least one dividing groove disposed on the first panel and dividing the first panel into multiple sections;
multiple pressing portions respectively disposed in the sections of the first panel; and
multiple first contact elements respectively disposed in the sections of the first panel and respectively corresponding to the pressing portions, and each first contact element moving together with a corresponding pressing portion along a moving path;
a circuit board having multiple signal generators disposed on the circuit board, the signal generators respectively corresponding to the first contact elements, and each signal generator disposed on the moving path of a corresponding first contact element; and
a housing for mounting the pressing module and the circuit board, and the housing having
a second panel disposed between the pressing module and the circuit board;
multiple through holes formed through the second panel and respectively mounted around the first contact elements; and
multiple dividing protrusions disposed on the second panel, each dividing protrusion disposed between two of the first contact elements that are adjacent to each other, and each dividing protrusion having a distal end, the distal end of the dividing protrusion corresponding to the first panel.

2. The multi-directional key assembly as claimed in claim 1, wherein the pressing portions and the first contact elements are respectively disposed on two opposite surfaces of the first panel.

3. The multi-directional key assembly as claimed in claim 1, wherein the pressing module is mounted on one of two opposite side portions of the housing.

4. The multi-directional key assembly as claimed in claim 1, wherein the circuit board is mounted in the housing.

5. The multi-directional key assembly as claimed in claim 1, wherein the housing is securely attached to a peripheral edge of the circuit board.

6. The multi-directional key assembly as claimed in claim 1, wherein the housing is securely attached to a peripheral edge of the circuit board.

7. The multi-directional key assembly as claimed in claim 1, wherein each dividing protrusion is connected to the second panel via a buffering structure.

8. The multi-directional key assembly as claimed in claim 1, wherein the pressing module further has multiple engaging elements engaging the housing.

9. The multi-directional key assembly as claimed in claim 1, wherein
the pressing module further has at least one second contact element disposed on the first panel, and each of the at least one second contact element corresponds to and is driven by one of the pressing portions; and
the housing further has at least one flexible indirect contact element disposed on the second panel, and the at least one indirect contact element is driven by the at least one second contact element to press against at least one of the signal generators.

10. The multi-directional key assembly as claimed in claim 9, wherein each of the at least one indirect contact element corresponds to one of the at least one second contact element, and corresponds to one of the signal generators.

11. The multi-directional key assembly as claimed in claim 9, wherein the corresponding second contact element, indirect contact element, and signal generator are arranged in a line.

12. The multi-directional key assembly as claimed in claim 9, wherein each of the at least one indirect contact element is connected to the second panel via at least one resilient element.

13. The multi-directional key assembly as claimed in claim 1, wherein the pressing module comprises multiple dividing grooves disposed on the same surface of the first panel or disposed on opposite surfaces of the first panel.

14. The multi-directional key assembly as claimed in claim 1, wherein the pressing module comprises multiple dividing grooves being parallel to each other or crossing each other.

15. The multi-directional key assembly as claimed in claim 1, wherein each of the at least one dividing groove extends linearly or is in an arc shape.

16. The multi-directional key assembly as claimed in claim 1, wherein the dividing protrusions are disposed adjacent to the dividing grooves, or the dividing protrusions protrude in the dividing grooves and abut the first panel.

17. The multi-directional key assembly as claimed in claim 1, wherein each through hole has a hole edge defined around the through hole, and the hole edge holds a corresponding first contact element.
